(19) United States
(12) Patent Application Publication
(10) Pub. No.: US 2015/0203596 A1
(43) Pub. Date: Jul. 23, 2015

(54) METHOD FOR PREPARING ACETYLATED CELLULOSE ETHERS HAVING IMPROVED ANTI-FOULING PROPERTIES, AND ACETYLATED CELLULOSE ETHERS PREPARED BY SAME

(71) Applicant: SAMSUNG FINE CHEMICALS CO., LTD, Ulsan (KR)

(72) Inventors: Tae Hong Kim, Ulsan (KR); Byoung Hee Son, Ulsan (KR)

(73) Assignee: SAMSUNG FINE CHEMICALS CO., LTD, Ulsan (KR)

(21) Appl. No.: 14/420,965

(22) PCT Filed: Feb. 18, 2013
(86) PCT No.: PCT/KR2013/001251

§ 371 Date: Feb. 11, 2015

(30) Foreign Application Priority Data
Dec. 7, 2012 (KR) 10-2012-0142218

(51) Int. Cl. C08B 13/00; B01D 65/08; C02F 1/44; B01D 71/14

(52) U.S. Cl. CPC C08B 13/00; B01D 71/14; B01D 65/08; C02F 1/44; C02F 2303/20; B01D 2325/36

(57) ABSTRACT

The present invention relates to a method for preparing acetylated cellulose ethers having improved anti-fouling properties and to acetylated cellulose ethers prepared by same. The method for preparing acetylated cellulose ethers having improved anti-fouling properties comprises the steps of: cross-linking cellulose ethers; and acetylating the cross-linked cellulose ethers. The acetylated cellulose ethers prepared by the method may activate the hydroxyl group which is made into blocks by the agglomeration between polymers performed by the materials for cross-linking the cellulose ethers, and may introduce thereto an additional hydrophilic group so as to increase hydrophilic properties, and thus may improve anti-fouling properties when applied to water-treatment membranes.

### TECHNICAL FIELD

The present invention relates to a method for preparing an acetylated cellulose ester having improved anti-fouling properties, and an acetylated cellulose ester prepared by the same. More particularly, the present invention relates to a method for preparing an acetylated cellulose ester having improved anti-fouling properties where the acetylated cellulose ester is obtained by acetylating a cross-linked cellulose ester to introduce additional hydrophilic groups, and an acetylated cellulose ester prepared by the same.

### BACKGROUND ART

Materials for water-treatment membranes should have anti-fouling properties, chlorine resistance and tensile strength while exhibiting high hydrophilic properties. Specifically, the risk of contamination may be lowered as the hydrophilic properties increases, the membranes may be washed without any damage as the chlorine resistance increases, and the membranes may cope with a certain pressure even when used for a long period of time as the tensile strength increases.

In the prior art, cellulose acetate capable of lowing contamination of membranes due to low tensile strength and chlorine resistance but high hydrophilic properties to extend washing cycles, and polyvinylidene fluoride favorable for washing due to low hydrophilic properties but high chlorine resistance have been widely used as the materials for water-treatment membranes.

However, the cellulose acetate has an advantage in that it is possible to minimize the contamination of the membranes due to excellent hydrophilic properties, but has a problem in that it has low mechanical strength. That is, since cellulose that is a source material should be acetylated while destroying a crystal structure of the cellulose upon preparation of the cellulose acetate, a polar catalyst such as an inorganic acid is used for acetylation. Therefore, the cellulose acetate finally prepared by cleaving the main chain of cellulose has a problem in that it has a small molecular weight and a remarkably low mechanical strength.

Also, since the polyvinylidene fluoride has excellent mechanical strength and chlorine resistance but low hydrophilic properties, and thus membranes including the polyvinylidene fluoride have a problem in that they may be easily contaminated, and thus should be often washed.

As a result, it is currently proposed that an acetylated cellulose ester synthesized by acetylating a cellulose ester is used for water-treatment membranes. However, the water-treatment membranes may be contaminated due to a fouling phenomenon caused by organic matters when the acetylated cellulose ester is actually used for the water-treatment membranes, resulting in degraded durability of the membranes and frequent breakdowns. Therefore, development of materials capable of improving the fouling of membranes by organic matters is demanded.

Accordingly, the present inventors have found that, when a cellulose ester that is a source material for preparing an acetylated cellulose ester to enhance hydrophilic properties is cross-linked, and acetylated to improve anti-fouling properties of a membrane material, it is possible to prepare an acetylated cellulose ester whose hydrophilic properties are enhanced by hydroxyl groups present in the cross-linked material, and that the anti-fouling properties of the water-treatment membranes can be remarkably improved due to presence of the acetylated cellulose ester having such additional hydrophilic groups introduced thereto. Therefore, the present invention has been completed based on these facts.

### DISCLOSURE

### Technical Problem

Therefore, the present invention is designed to solve the problems of the prior art, and therefore it is an object of the present invention to provide a method for preparing an acetylated cellulose ester having improved anti-fouling properties.

It is another object of the present invention to provide an acetylated cellulose ester having improved anti-fouling properties.

### Technical Solution

According to an aspect of the present invention, there is provided a method for preparing an acetylated cellulose ester having improved anti-fouling properties, which includes the steps of cross-linking a cellulose ester, and acetylating the cross-linked cellulose ester.

The cellulose ester may preferably have at least one substituent selected from the group consisting of methyl, ethyl, propyl, hydroxymethyl, hydroxyethyl, and hydroxypropyl groups. Particularly preferably, the cellulose ester may be at least one selected from the group consisting of methylcellulose, hydroxypropyl methylcellulose, and hydroxyethyl methylcellulose.

A material for cross-linking the cellulose ester may be preferably at least one selected from the group consisting of glyoxal and glutaraldehyde. Preferably, the glyoxal, and glutaraldehyde may be cross-linked with the cellulose ester at a content of 0.5 to 2.5% by weight, based on the total weight of the cellulose ester.

The acetylated cellulose ester may preferably have a degree of substitution with alkyl groups (DS) of 1 to 2, a degree of substitution with hydroxyalkyl groups (MS) of 0 to 1, and a degree of substitution with acetyl groups (DS) of 1 to 2.

According to another aspect of the present invention, there is provided an acetylated cellulose ester in which hydrogen atoms in hydroxyl groups included in a monomer of the cross-linked cellulose ester are substituted with acetyl groups

### Advantageous Effects

The acetylated cellulose ester obtained by acetylating a cross-linked cellulose ester to introduce additional hydrophilic groups thereto can be useful in activating hydroxyl groups which are blocked by agglomeration between polymers by cross-linking, and introducing additional hydrophilic groups thereto so as to causing an increase in hydrophilic properties, thereby improving anti-fouling properties.

### DESCRIPTION OF DRAWING

These and other features, aspects, and advantages of preferred embodiments of the present invention will be more fully described in the following detailed description, taken accompanying drawing. In the drawing:

FIG. 1 is a graph illustrating the results obtained by measuring anti-fouling properties of acetylated cellulose esters prepared according to one exemplary embodiment of the present invention.

### BEST MODE

Hereinafter, the method for preparing an acetylated cellulose ester according to one exemplary embodiment of the present invention, and the acetylated cellulose ester prepared by the same will be described in further detail.

The method for preparing an acetylated cellulose ester having improved anti-fouling properties according to one exemplary embodiment of the present invention includes the steps of cross-linking a cellulose ester, and acetylating the cross-linked cellulose ester.

In the step of cross-linking the cellulose ester, a material for cross-linking the cellulose ester is mixed, and stirred at 60 to 100° C., preferably 80° C., for 0.5 hours to 2 hours, preferably for an hour, to cross-link the cellulose ester.

The material for cross-linking a cellulose ester is preferably selected from the group consisting of glyoxal and glutaraldehyde, and more preferably glyoxal.

As the cellulose ester is cross-linked, especially cross-linked with glyoxal, hydroxyl groups blocked by agglomeration between cellulose ester polymers may be activated. Also, the hydrophilic properties may be enhanced as the hydrophilic groups are further introduced to the acetylated cellulose ester, thereby improving anti-fouling properties.

The material for cross-linking a cellulose ester is preferably cross-linked with the cellulose ester at a content of 0.5 to 2.5% by weight, based on the total weight of the cellulose ester. When the material is present at a content of less than 0.5% by weight and greater than 2.5% by weight to cross-link the cellulose ester, this content range is undesirable since it is impossible to obtain the above-described anti-fouling properties.

The cross-linked cellulose ester is prepared by esterifying hydroxyl groups of cellulose. That is, a cellulose ester is formedby blocking some of the hydroxyl groups in the structure of cellulose by esterification of cellulose, or by substituting hydrogen atoms in the hydroxyl groups with another substituent. In this case, the main chain of cellulose is not cleaved, but maintained intact. However, the cellulose is converted into an amorphous structure due to destruction of hydrogen bonds in cellulose, thereby resulting in water-soluble cellulose ester having a high molecular weight.

In the case of the cross-linked cellulose ester, the hydroxyl groups are present in the material for cross-linking a cellulose ester in addition to the three hydroxyl groups present in the monomer. In this case, the acetylation reaction occurs only in the hydroxyl groups present in the cellulose ester monomer.

The cross-linked hydroxyl groups are cleaved under neutral pH conditions with time. To verify this result, a degree of acetylation of the acetylated cellulose ester synthesized using the cross-linked cellulose ester with time is measured. When the cross-linked hydroxyl groups are acetylated, the degree of acetylation value decreases with time. However, the measurement results show that a change in the degree of acetylation with time is not observed.

The cellulose ester has at least one substituent selected from the group consisting of methyl, ethyl, propyl, hydroxymethyl, hydroxyethyl, and hydroxypropyl groups. For example, the cellulose ester may include hydroxyethyl methylcellulose, hydroxypropyl methylcellulose, or methyl cellulose.

Also, the degree of substitution with alkyl groups (such as a methyl group, an ethyl group, or a propyl group) (DS) and the degree of substitution with hydroxyalkyl groups (such as a hydroxymethyl group, a hydroxyethyl group, or a hydroxypropyl group) (MS) are basic degrees of substitution of cellulose esters generally used in the related art. Specifically, the degree of substitution with alkyl groups (DS) is in a range of 1 to 2, the degree of substitution with hydroxyalkyl groups (MS) is in a range of 0 to 1.

The term “degree of substitution (DS)” refers to an average number of hydroxyl groups substituted with alkyl groups per anhydroglucose unit. When three hydroxyl groups are present per anhydroglucose unit, a theoretical degree of substitution (DS) is 3. However, since multifunctional or polymerizable substituents react with hydrogen atoms in the hydroxyl groups included in the anhydroglucose unit and also react with themselves, the degree of substitution (DS) is not limited to 3.

The following Formulas 1 and 2 show a process of esterifying an anhydroglucose that is a base repeating unit of cellulose. In particular, Formula 1 shows that cellulose is esterified to be converted into a hydroxyalkyl alkylcellulose, Formula 2 shows that cellulose is esterified to be converted into an alkylcellulose.

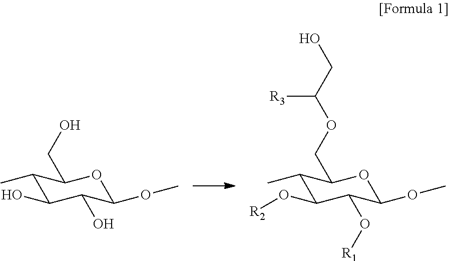

In Formula 1, R₁ and R₂ are each independently a hydrogen, methyl, ethyl, propyl, hydroxymethyl, hydroxyethyl, or hydroxypropyl group, and R₃ is hydrogen, or a methyl group.

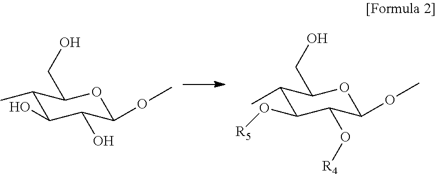

In Formula 2, R₄ and R₅ are each independently hydrogen, or a methyl, ethyl or propyl group.

The basic repeating units of the cellulose ester represented by Formulas 1 and 2 thus prepared are cross-linked with the material for cross-linking the cellulose ester to introduce additional hydrophilic groups to the acetylated cellulose ester.

In the step of acetylating the cross-linked cellulose ester, hydrogen atoms in the hydroxyl groups included in the cellulose ester are substituted with acetyl groups (CH₃CO⁻). For this purpose, the cross-linked cellulose ester may be acetylated by mixing acetic acid, anhydrous acetic acid, sodium acetate or a combination thereof with the cross-linked cellulose ester, and stirring the resulting mixture at a temperature of 60 to 80° C. for 6 to 8 hours. Here, acetic acid, pyridine, isopropyl alcohol (IPA) or the like may be used as a reaction solvent, and sodium acetate or phosphoric acid may also be used as a catalyst.

In addition, the acetylated cellulose ester obtained by the method as described above has a degree of substitution with acetyl groups of 1 to 2.

The acetylated cellulose ester obtained by the preparation method as described above has a number average molecular weight of 300,000 to 1,000,000, a contact angle of 25 to 45°, and a tensile strength of 45 to 75 MPa. Here, the term “contact angle” refers to an angle formed between a free surface of water and a flat surface of a film when the film prepared from the acetylated cellulose ester comes in contact with water. Also, the term “tensile strength” refers to a tensile strength of the film prepared from the acetylated cellulose ester.

The acetylated cellulose ester has a degree of substitution with alkyl groups (DS) of 1 to 2, a degree of substitution with hydroxyalkyl groups (MS) of 0 to 1 and a degree of substitution with acetyl groups (DS) of 1 to 2.

Since the above-described acetylated cellulose ester is not dissolved in water but is readily dissolved in an organic solvent such as acetone, and has a high molecular weight to exhibit excellent mechanical strength, the acetylated cellulose ester may be used for water-treatment membranes, and the like.

### MODE FOR INVENTION

Hereinafter, the present invention will be described in detail with reference to the following Examples. However, it should be understood that the following Examples are not intended to limit the scope of the present invention.

### Examples 1 to 5

### Preparation of Acetylated Cellulose Esters

150 g of a cellulose ester was added to a 3 L reactor equipped with a condenser, a thermometer and a stirrer, and glyoxal was added to the reactor at contents as listed in the following Table 1. Thereafter, the resulting mixture was reacted at 80° C. for an hour while stirring at 150 rpm to cross-link glyoxal with the cellulose ester. 1,050 g of acetic acid, 300 g of sodium acetate, and 750 g of an acetic anhydride were added to the glyoxal cross-linked cellulose ester, and then reacted at 70° C. for 7 hours while stirring at 650 rpm to prepare an acetylated cellulose ester. In this case, the acetic acid was used as a solvent, and the sodium acetate was used as a catalyst. Subsequently, the contents in the reactor were sprayed, coagulated in a 10 L coagulating bath, washed five times with clean water, and then dried. The degree of substitution with methyl groups (DS) and the degree of substitution with hydroxypropyl groups (MS) of the cellulose ester used in each of Examples, the quantity of glyoxal used, and the molar ratio of the acetic anhydride used per anhydroglucose unit included in each cellulose ester are listed in the following Table 1.

### Comparative Example 1

An acetylated cellulose ester was prepared in the same manner as in Examples 1 to 5, except that the cellulose ester was not cross-linked with glyoxal.

TABLE 1

| | Cellulose ester cross-linked with glyoxal | | | | |
|---|---|---|---|---|---|
| | | Degree of | Degree of | | |
| | | substitution | substitution | | anhydrous acetic |
| | Type of | with | with | Glyoxal | acid/anhydroglucose |
| | cellulose | methyl | hydroxypropyl | (% by | unit ratio (molar |
| | ester | groups | groups | weight) | ratio) |
| Example 1 | HPMC | 1.84 | 0.25 | 0.5 | 5.95 |
| Example 2 | HPMC | 1.84 | 0.25 | 1.0 | 5.95 |
| Example 3 | HPMC | 1.84 | 0.25 | 1.5 | 5.95 |
| Example 4 | HPMC | 1.84 | 0.25 | 2.0 | 5.95 |
| Example 5 | HPMC | 1.84 | 0.25 | 2.5 | 5.95 |
| Comparative | HPMC | 1.84 | 0.25 | — | 5.95 |
| Example 1 | | | | | |

As listed in Table 1, hydroxypropyl methylcellulose (HPMC) used herein as the cellulose ester is a commercialized standard produced by Samsung Fine Chemicals Co., Ltd.

### Experimental Example

The degree of substitution with acetyl groups, the contact angle with water, the tensile strength, the molecular weight and the anti-fouling properties of each of the acetylated cellulose esters prepared in Examples 1 to 5 and Comparative Example 1 were measured as follows. The measurement results are listed in the following Table 2.

Measurement of Degree of Substitution with Acetyl Groups

Free acetic acid formed by saponification of a sample of each of the acetylated cellulose esters prepared in Examples 1 to 5 and Comparative Example 1 was titrated with an alkali, and the degree of substitution with acetyl groups of each of the samples was measured according to ASTM D871-96.

Measurement of Contact Angle and Tensile Strength

10 g of each of the samples prepared in Examples 1 to 5 and Comparative Example 1 was dissolved in 90 g of dimethylformamide (DMF), and 10 g of the resulting solution was drawn, casted on a glass plate to a thickness of 2 mm, and then dried in a vacuum oven. In this case, the vacuum oven was maintained at a temperature of 60° C., and the thickness of the final film was 0.2±0.02 mm.

(1) Measurement of Contact Angle

The contact angle between water and each of the prepared films was measured using a contact angle measuring machine (KSV, Theta optical tensimeter) in a state in which each film came in contact with water. Here, a lower contact angle means higher hydrophilic properties.

(2) Measurement of Tensile Strength

The tensile strength of each of the films was measured using a strength measuring machine (Instron, No. 5569).

Measurement of Molecular Weight

Each of the samples was measured for weight average molecular weight (Mw) using size exclusion chromatography (Agilent, HP 1100). Specifically, 0.1 g of each sample was dissolved in 100 g of dimethylformamide (HPLC-grade), and the resulting solution was measured under conditions of a temperature of 25° C. and a flow rate of 10 ml/min using dimethylformamide as a mobile phase.

TABLE 2

| | Degree of | | | |
|---|---|---|---|---|
| | substitution | Contact | Tensile | Molecular |
| | with acetyl | angle | strength | weight |
| Items | groups | (°) | (MPa) | (Dalton) |
| Example 1 | 1.16 | 43 | 50 | 425,000 |
| Example 2 | 1.15 | 40 | 48 | 482,000 |
| Example 3 | 1.14 | 36 | 68 | 420,000 |
| Example 4 | 1.19 | 39 | 75 | 415,000 |
| Example 5 | 1.10 | 37 | 51 | 455,000 |
| Comparative | 1.15 | 49 | 66 | 472,000 |
| Example 1 | | | | |

As listed in Table 2, it could be seen that the respective acetylated cellulose esters prepared from the glyoxal cross-linked cellulose ester in Examples 1 to 5 had similar tensile strength and molecular weight to the acetylated cellulose ester prepared from the non-cross-linked cellulose ester in Comparative Example 1, but the acetylated cellulose esters of Examples 1 to 5 had a lower contact angle than that of Comparative Example 1, indicating that the acetylated cellulose esters of Examples 1 to 5 had improved hydrophilic properties.

Evaluation of Anti-Fouling Properties—Flux

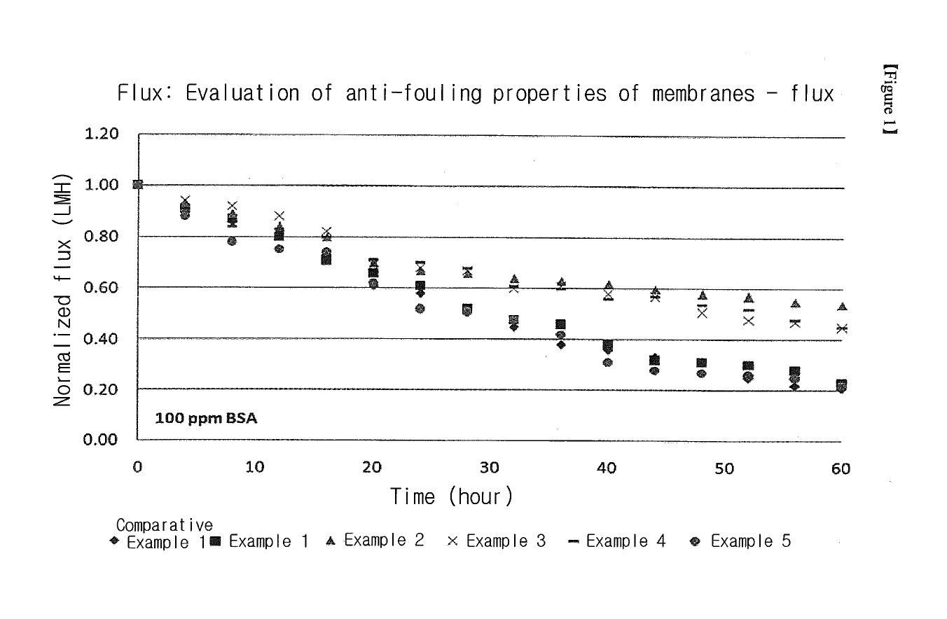

Each of the acetylated cellulose esters obtained in Examples 1 to 5 and Comparative Example 1 was mounted as a membrane in a cross-flow membrane cell made from a stainless material, and compressed with 10 L of ultra-pure water at a pressure of 2 kgf/cm². Thereafter, 100 ppm BSA was added to the ultra-pure water, and a change in water permeability at a pressure of 1 kgf/cm² was measured. The results are shown in FIG. 1. The normalized flux in a longitudinal direction of the graph shown in FIG. 1 represents LMH (volume, area and time), that is, the quantity of water permeated per unit area with time (ΔV/A*Δt).

As shown in FIG. 1, it was revealed that a decrease in flux with time was remarkably low in the case of Examples 2 to 4, compared to that of Comparative Examples, and that a decrease in flux in Examples 1 and 5 in which the content of the cross-linked glyoxal was a critical value was similar to that of Comparative Examples, indicating that the acetylated cellulose esters prepared from the cross-linked cellulose ester in which glyoxal was present at a predetermined content had remarkably improved anti-fouling properties.

1. A method for preparing an acetylated cellulose ester having improved anti-fouling properties, comprising the steps of:
cross-linking a cellulose ester; and
acetylating the cross-linked cellulose ester.

2. The method of claim 1, wherein the cellulose ester has at least one substituent selected from the group consisting of methyl, ethyl, propyl, hydroxymethyl, hydroxyethyl, and hydroxypropyl groups.

3. The method of claim 1, wherein the cellulose ester is at least one selected from the group consisting of methylcellulose, hydroxypropyl methylcellulose, and hydroxyethyl methylcellulose.

4. The method of claim 1, wherein a material for cross-linking the cellulose ester is at least one selected from the group consisting of glyoxal and glutaraldehyde.

5. The method of claim 4, wherein the material for cross-linking the cellulose ester is used at a content of 0.5 to 2.5% by weight, based on the total weight of the cellulose ester.

6. The method of claim 1, wherein the acetylated cellulose ester has a degree of substitution with alkyl groups (DS) of 1 to 2, a degree of substitution with hydroxyalkyl groups (MS) of 0 to 1, and a degree of substitution with acetyl groups (DS) of 1 to 2.

7. An acetylated cellulose ester having improved anti-fouling properties in which hydrogen atoms in hydroxyl groups included in a monomer of the cross-linked cellulose ester prepared as defined in claim 1 are substituted with acetyl groups.
